(19) United States
(12) Patent Application Publication
(10) Pub. No.: US 2023/0257310 A1
(43) Pub. Date: Aug. 17, 2023

(54) ULTRA-LOW THERMAL MASS REFRACTORY ARTICLE

(71) Applicant: UNIFRAX I LLC, Tonawanda, NY (US)

(72) Inventors: Sergio David FERNANDES, JR., Campinas (BR); Claudemir COSTA, Vinhedo (BR)

(21) Appl. No.: 18/301,161

(22) Filed: Apr. 14, 2023

Related U.S. Application Data
(63) Continuation of application No. PCT/US2021/071924, filed on Oct. 19, 2021.
(60) Provisional application No. 63/094,064, filed on Oct. 20, 2020.

(51) Int. Cl. C04B 35/80; C04B 35/628; C04B 35/624; F27D 1/00

(52) U.S. Cl. CPC C04B 35/80; C04B 35/62886; C04B 35/62849; C04B 35/624; F27D 1/0009; C04B 2235/5228; C04B 2235/5232; C04B 2235/3418; C04B 2235/616; C04B 2235/604; C04B 2235/606; C04B 2235/612; C04B 2235/9669; C04B 2235/77; C04B 2235/9615; F27D 1/004

(57) ABSTRACT

An ultra-low thermal mass refractory article includes fibers impregnated with a colloidal inorganic oxide. The refractory article has at least one of the following properties: (i) a density of 500 kg/m³ to 1500 kg/m³; (ii) a thermal conductivity of 1.0 Wm/K or less at 700° C.; and/or (iii) a linear thermal shrinkage at 1400° C. of less than 2.5%.

### CROSS-REFERENCE TO RELATED APPLICATIONS

This application is a continuation of PCT International Patent Application No. PCT/US2021/071924, filed Oct. 19, 2021, which claims benefit of U.S. Provisional Patent Application No. 63/094,064 filed Oct. 20, 2020, titled “ULTRA-LOW THERMAL MASS REFRACTORY ARTICLE,” which is incorporated herein by reference in its entirety.

### TECHNICAL FIELD

The present disclosure relates to insulative materials, systems incorporating the same, and methods of making and using the same. More particularly, the present disclosure relates to ultra-low thermal mass (ULTM) refractory articles, such as supports, plates, bricks, or blocks.

### BACKGROUND OF THE INVENTION

Tunnel kilns or furnaces may be used to fire sanitaryware pieces (e.g., washbasins, toilets, etc.), stoneware, and other ceramics. Refractory plaques or refractory bricks have been used to support the ceramic work pieces during firing and to line the kiln or furnace. However, there remains a need for refractory articles having reduced thermal mass as well as improved durability.

### DETAILED DESCRIPTION

The ULTM refractory article of the present disclosure may be characterized by one or more of its density, thermal conductivity, and linear thermal shrinkage.

In particular, according to one or more embodiments, the ULTM refractory article of the present disclosure has a density of at least 500 kg/m³, at least 600 kg/m³, at least 700 kg/m³, at least 800 kg/m³, at least 900 kg/m³, at least 950 kg/m³, at most 1500 kg/m³, at most 1400 kg/m³, at most 1300 kg/m³, at most 1200 kg/m³, at most 1100 kg/m³, at most 1000 kg/m³, at most 900 kg/m³, at most 850 kg/m³, or any logical combination of the foregoing upper and lower bounds, such as 500 kg/m³ to 1500 kg/m³, 600 kg/m³ to 1200 kg/m³, or 800 kg/m³ to 1000 kg/m³. In contrast, traditional refractories have a density of around 3,000 kg/m³. Due to the low density, the ULTM refractory article may weigh less than half as much as traditional refractories.

Further, according to one or more embodiments, the ULTM refractory article has a thermal conductivity (k-value) at 700° C. of at most 1 Wm/K, at most 0.8 Wm/K, at most 0.6 Wm/K, at most 0.5 Wm/K, at most 0.3 Wm/K, at most 0.2 Wm/K, or about 0.2 Wm/K. On the other hand, traditional refractories have a k-value of around 18 at 700° C. The lower the k-value, the better the material is for insulation.

Additionally, according to one or more embodiments, the ULTM refractory article has a linear thermal shrinkage at 1400° C. of at most 2.5%, at most 2.0%, at most 1.5%, at most 1.0%, or less than 1.0%. Comparatively, traditional refractories have a linear thermal shrinkage of around 5.0% at 1400° C.

In view of the properties discussed above, the ULTM refractory article may insulate at temperatures of up to 1000° C., 1200° C., 1300° C., 1500° C., or 1650° C. Further, the ULTM refractory articles heat up and cool down faster than the traditional refractories due to the properties discussed above.

Generally, the process for making the ULTM refractory article includes impregnating insulating ceramic (inorganic) fibers with at least one colloidal inorganic oxide, such as colloidal silica, alumina and/or zirconia, placing the impregnated fibers in a mold and pressing the impregnated fibers to a desired thickness, shape, and size, drying in an oven to produce a dried board having the desired characteristics, and if desired, cutting the dried fibers to final size. In alternative embodiments, the ULTM refractory article can be produced by replacing the colloidal inorganic oxide with phosphoric acid.

The ceramic fibers useful for making the ULTM refractory article can be manufactured using known methods, or it can be acquired commercially. In some embodiments, the fibers comprise polycrystalline wool (PCW), and suitable products containing PCW are currently available from Unifrax I LLC (Niagara Falls, N.Y.) under the trademark SAFFIL. Other suitable starting ceramic fiber blankets and boards are currently available from Unifrax I LLC under the trademarks DURABLANKET and DURABOARD.

In one or more embodiments, the ceramic fibers have an alumina content of about 43 to about 47% and a silica content of about 53 to about 57% by weight (i.e., aluminosilicate fibers (RCF)). In other embodiments the ceramic fibers may have an alumina content of about 29 to about 31%, a silica content of about 53 to about 55%, and a zirconia content of about 15 to about 17% by weight. The fibers may be in the form of a blanket having a density on the order of about 30 to about 192 kg/m³, in some embodiments about 64 to about 128 kg/m³, and a temperature grade of about 1260° C. to about 1430° C.

In other embodiments, the ceramic fibers have an alumina content of about 42 to about 50% and a silica content of about 50 to about 58% by weight. In other embodiments, the ceramic fibers may have an alumina content of about 28 to about 32%, a silica content of about 52 to about 56%, and a zirconia content of about 14 to about 18% by weight (i.e., alumino zirconia silicate (AZS) fibers). The ceramic fibers may be in the form of boards having a density on the order of about 150 to about 350 kg/m³, a loss on ignition (LOI) of about 3 to about 10%, and a temperature grade of about 1260° C. In one or more embodiments, the ceramic fibers may include alkaline earth silicate (AES) fibers, such as those available from Unifrax I LLC under the mark ISOFRAX, and/or high temperature ceramic fibers such as high alumina fibers, such as those available from Unifrax I LLC under the mark FIBERMAX.

The colloidal inorganic oxide solution compositions that may be used to impregnate the ceramic fibers may contain at least one colloidal inorganic oxide, such as colloidal silica, alumina, zirconia, titania, ceria, and/or yttria. Commercially available formulations of the colloidal inorganic oxide may be utilized, by way of illustration and not limitation, NALCO colloidal silica comprising 40% solids, available from Nalco Company (Naperville, Ill.). However, other grades of colloidal silica may also be used, such as 30% solids content or less, or alternatively greater than 40% solids content.

The colloidal inorganic oxide solution composition may comprise about 30 to 100% by weight colloidal inorganic oxide, such as colloidal silica. In certain embodiments, the colloidal inorganic oxide solution may comprise about 50 to about 90% colloidal inorganic oxide, such as colloidal silica, and in other embodiments, about 80 to 100% colloidal inorganic oxide, such as colloidal silica.

Other components of the colloidal inorganic oxide solution may include a gelling agent and water in an amount sufficient to solubilize the gelling agent. Gelling agent components may include inorganic salts or oxides that promote the setting or gelling of the colloidal inorganic oxide, for example in the case of colloidal silica, such as ammonium acetate, calcium chloride, magnesium chloride, magnesium oxide, and the like, and an acid, such as acetic acid, hydrochloric acid, phosphoric acid, and the like. The type and concentration of gelling agents are selected to destabilize the colloidal suspension, and to permit the gel or set of the inorganic oxide component in place during pressing of the ULTM refractory article.

Gel time can be controlled, in part, by the concentration of the gelling agent, as the gelling time generally decreases with an increase in temperature. The amount of inorganic salt or oxide gelling agent may vary from about 0.01 to about 10% by weight of the solution. The amount of acid may vary from about 0.01 to about 10% by weight. Gel time can be controlled, in part, by the concentration of the gelling agent, as the gelling time decreases with an increase in temperature. The amount of water sufficient to solubilize the gelling agent may vary from 0 to about 70% of the solution. The colloidal inorganic oxide solution may additionally comprise a colorant, in some embodiments, in an amount of about 0.01% to about 10% by weight, such as to enable the end product to be distinguished by color.

In the process of making the ULTM refractory article, the untreated ceramic fibers may be impregnated with the colloidal silica solution to the point of saturation. The impregnated fibers can be pressed at a pressure ranging from about 5 to about 100 tons. In certain embodiments, pressures ranging from about 20 to about 40 tons can be used. In one or more embodiments, the impregnated fibers can be kept in under the above pressure for a time ranging from about 1 to about 120 minutes or about 1 to about 5 minutes. The pressed fibers can be dried in an oven at a temperature ranging from about 40 to about 350° C. or about 80 to about 150° C.

Although the ULTM refractory article has been described as useful as a furnace lining and workpiece support, the ULTM refractory article may be used in any other appropriate application. For instance, the ULTM refractory article may be employed as a backup plate for metal handling apparatuses, such as ladles, torpedo cars, trough runners, tundishes and molds. Namely, the ULTM refractory article may replace the backup plate described in U.S. Pat. No. 7,413,797, which is hereby incorporated in its entirety.

It is understood that variations may be made in the foregoing without departing from the scope of the disclosure.

In one or more embodiments, the elements and teachings of the various disclosed embodiments may be combined in whole or in part in some or all of the disclosed embodiments. In addition, one or more of the elements and teachings of the various disclosed embodiments may be omitted, at least in part, or combined, at least in part, with one or more of the other elements and teachings of the various disclosed embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In one or more embodiments, while different steps, processes, and procedures are described as appearing as distinct acts, one or more of the steps, one or more of the processes, or one or more of the procedures may also be performed in different orders, simultaneously or sequentially. In one or more embodiments, the steps, processes or procedures may be merged into one or more steps, processes or procedures. In one or more embodiments, one or more of the operational steps in each embodiment may be omitted. Moreover, in some instances, some features of the present disclosure may be employed without a corresponding use of the other features.

Although several embodiments have been disclosed in detail above, the embodiments disclosed are not limiting, and those skilled in the art will readily appreciate that many other modifications, changes, and substitutions are possible in the disclosed embodiments without materially departing from the novel teachings and advantages of the present disclosure. Accordingly, all such modifications, changes, and substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A refractory article comprising inorganic fibers and having at least one of the following properties:
(i) a density of 500 kg/m³ to 1500 kg/m³;
(ii) a thermal conductivity of 1.0 Wm/K or less at 700° C.; and/or
(iii) a linear thermal shrinkage at 1400° C. of less than 2.5%.

2. The refractory article of claim 1, wherein the inorganic fibers are selected from polycrystalline wool, aluminosilicate fibers, alumino zirconia silicate fibers, and/or alkaline earth silicate fibers.

3. The refractory article of claim 1, comprising a thermal conductivity of 0.5 Wm/K or less at 700° C.

4. The refractory article of claim 1, comprising a thermal conductivity of 0.2 Wm/K or less at 700° C.

5. The refractory article of claim 1, comprising a linear thermal shrinkage at 1400° C. of less than 1.5%.

6. The refractory article of claim 1, comprising a linear thermal shrinkage at 1400° C. of less than 1.0%.

7. The refractory article of claim 1, comprising a density of 800 kg/m³ to 1000 kg/m³.

8. The refractory article of claim 1, wherein the refractory article has the following properties:
(i) a density of 800 kg/m³ to 1000 kg/m³;
(ii) a thermal conductivity of 0.2 Wm/K or less at 700° C.; and
(iii) a linear thermal shrinkage at 1400° C. of less than 1.0%.

9. A method of forming a refractory article, the method comprising:
impregnating inorganic fibers with at least one colloidal inorganic oxide or phosphoric acid,
placing the impregnated fibers in a mold;
pressing the impregnated fibers in the mold; and
drying the pressed impregnated fibers to form the refractory article.

10. The method of claim 9, wherein the inorganic fibers are selected from polycrystalline wool, aluminosilicate fibers, alumino zirconia silicate fibers, and/or alkaline earth silicate fibers.

11. The method of claim 9, comprising impregnating the inorganic fibers with the phosphoric acid.

12. The method of claim 9, comprising impregnating the inorganic fibers with the at least one colloidal inorganic oxide, wherein the at least one colloidal inorganic oxide comprises colloidal silica, colloidal alumina, and/or colloidal zirconia.

13. The method of claim 9, further comprising cutting the refractory article.

14. The method of claim 9, comprising impregnating the inorganic fibers with a colloidal solution comprising the at least one colloidal inorganic oxide and a gelling agent.

15. The method of claim 14, wherein the at least one colloidal oxide comprises colloidal silica and the gelling agent comprises ammonium acetate, calcium chloride, magnesium chloride, magnesium oxide, acetic acid, hydrochloric acid, phosphoric acid, or combinations thereof.

16. The method of claim 9, wherein the refractory article has at least one of the following properties:
(i) a density of 500 kg/m³ to 1500 kg/m³;
(ii) a thermal conductivity of 1.0 Wm/K or less at 700° C.; and/or
(iii) a linear thermal shrinkage at 1400° C. of less than 2.5%.

17. The method of claim 9, wherein the refractory article has the following properties:
(i) a density of 500 kg/m³ to 1500 kg/m³;
(ii) a thermal conductivity of 1.0 Wm/K or less at 700° C.; and
(iii) a linear thermal shrinkage at 1400° C. of less than 2.5%.

18. A support plate for a furnace comprising the refractory article of claim 1.

19. An insulating brick for lining a furnace comprising the refractory article of claim 1.

20. A backup plate for ladle, torpedo car, trough runner, tundish or mold comprising the refractory article of claim 1.
